(19) United States
(12) Patent Application Publication
(10) Pub. No.: US 2026/0155327 A1
(43) Pub. Date: Jun. 4, 2026

(54) IMPROVED COOLING X-RAY TUBE ANODE HEAD

(71) Applicant: incoatec GmbH, Geesthacht (DE)

(72) Inventors: Moritz Schlie, Hamburg (DE); Stephan Gabriel, Dettenheim (DE); Wilson Heiler, Karlsdorf-Neuthard (DE)

(73) Assignee: incoatec GmbH, Geesthacht (DE)

(21) Appl. No.: 19/404,849

(22) Filed: Dec. 1, 2025

(30) Foreign Application Priority Data
Dec. 4, 2024 (DE) 102024136111.5

(51) Int. Cl. H01J 35/12; H05G 1/10

(52) U.S. Cl. CPC H01J 35/13; H05G 1/10; H01J 2235/1204; H01J 2235/1262; H01J 2235/1266

(57) ABSTRACT

An x-ray tube includes a source for releasing electrons and an anode head with a central axis. A target is formed on an end face of the anode head, on which target during operation the electrons impinge in an excited region. The anode head provides a flow path for a cooling fluid, which flow path leads from at least one inlet connection via a radially outer portion, further via a cooling gap, and further via a radially inner portion to at least one outlet connection. The excited region of the target is essentially annular, where in a region of the anode head opposite the excited region of the target, a local height of the cooling gap increases continuously from radially outside to radially inside. The x-ray tube can be operated at a higher power and/or with less wear.

### CROSS-REFERENCE TO RELATED APPLICATIONS

This application claims priority to German Patent Application No. DE 10 2024 136 111.5, filed on Dec. 4, 2024, the entire contents of which are hereby incorporated in full by this reference.

### DESCRIPTION

### Field of the Invention

The invention relates to an x-ray tube, comprising a source for releasing electrons and an anode head with a central axis, wherein a target is formed on an end face of the anode head, on which target during operation the electrons impinge in an excited region, wherein the anode head provides a flow path for a cooling fluid, which flow path leads from at least one inlet connection via a radially outer portion, further via a cooling gap, and further via a radially inner portion to at least one outlet connection.

### Background of the Invention

Such an x-ray tube is known from EP 4 141 905 A1.

X-ray radiation is used in a variety of ways to investigate the chemical and physical properties of samples and bodies of all kinds. For example, x-ray fluorescence can be used to determine the atomic composition of samples qualitatively and quantitatively. X-ray radiation is also able to penetrate into the interior of a body and irradiate it without destroying the body. This allows compositions in the interior of the body to be determined.

In many cases, it is desirable to use high-intensity x-ray radiation to make more accurate and/or faster x-ray measurements possible.

X-ray radiation is typically generated using a so-called x-ray tube. A source for releasing electrons, e.g., a filament, is arranged in an evacuated region of the x-ray tube. The source is connected as a cathode. A target, which is connected as an anode, is also arranged in the evacuated region. The target can consist, for example, of copper, rhodium, chromium, molybdenum, or silver. Electrons from the source are accelerated by an electric field toward the target and impinge thereon. The impinging electrons are slowed down, producing bremsstrahlung. In addition, the impinging electrons dislodge other electrons from the atoms of the material of the target; when the vacant electron shells are refilled, characteristic x-ray radiation is produced. The electrons impinging on the target heat the target considerably so that the target usually has to be actively cooled. If the target gets too hot, it may melt, which would destroy the x-ray tube. In practice, cooling of the target therefore often limits the power of the x-ray tube.

EP 4 141 905 A1 discloses an x-ray tube in which in a cathode housing an essentially cylindrical anode head forms a target on its end face. Electrons released from a thermionic cathode in the cathode housing are accelerated toward the target. An inlet line for a coolant is connected to a first channel in the anode head, which comprises an oblique portion and then a portion running along a central axis of the anode head. The first channel leads into a cooling gap below the target, which cooling gap is perpendicular to the central axis of the anode head and has a uniform height. The cooling gap transitions into an annular channel located radially outside in the anode head. A second channel for the coolant leads away from this annular channel and is connected to a return line. A flow of coolant (water) centrally and axially through the first channel, via the cooling gap from radially inside to outside, and outside in the annular gap axially back into the second channel cools the target or the anode head as a whole. Alternatively, the water flow can also be reversed.

This design can provide an x-ray tube with sufficient x-ray power for many purposes.

Depending on the heating power of the electrons impinging on the target, the water in the cooling gap below the target may partially evaporate and boiling bubbles form. It should be noted that, although the boiling bubbles (i.e., the water vapor) can absorb a significant amount of heat when they are formed due to the phase transition during evaporation, the water vapor in the boiling bubbles can only absorb and transport away a significantly smaller amount of heat than liquid water. If the boiling bubbles are not removed quickly enough, the cooling capacity in the anode head decreases significantly and the target may melt.

In addition, boiling bubbles that have formed can collapse again shortly after their formation (so-called cavitation), which leads to mechanical stress on the surrounding material. Although cavitation does not affect the cooling capacity, it increases wear on the anode head.

The power of the x-ray tube known from EP 4 141 905 A1 is selected such that melting of the target is avoided and wear due to cavitation remains within an acceptably low range.

DE 10 2017 216 059 A1 discloses an x-ray tube in which the target is arranged on a solid, hump-shaped base body.

US 2021/0249214 A1 describes an x-ray tube with cooling by means of a cooling fluid which flows in one design via a central feed chamber via a curved gap below the target into an annular, radially outer return chamber. The curved gap has a constant width.

DE 10 2016 000 033 B4 discloses an x-ray tube which has a target at a tapered end of a carrier body. The carrier body is coupled via a connecting body, a heat-dissipating body, and a region of insulation material to a cooling unit, which is located radially outside and may be water-cooled.

### SUMMARY OF THE INVENTION

### Object of the Invention

It is an object of the present invention to provide an x-ray tube that can be operated at a higher power and/or with less wear.

### Description of the Invention

This object is achieved according to the invention by an x-ray tube of the type mentioned at the outset, which is characterized in that the excited region of the target is essentially annular, and in that, in a region of the anode head opposite the excited region of the target, a local height of the cooling gap increases continuously from radially outside to radially inside.

The x-ray tube according to the invention ensures improved cooling. Due to the improved cooling, the x-ray tube can be operated at a higher x-ray power, or at the same x-ray power, with less wear and therefore a longer service life.

In the x-ray tube according to the invention, the cooling fluid flows in the cooling gap from radially outside to radially inside due to the provided connections (inlet connection and outlet connection). Boiling bubbles form in the cooling gap during operation. Through their formation (more precisely through the phase transformation from liquid water to water vapor or correspondingly in the case of other cooling fluids), the boiling bubbles achieve a noticeable cooling effect. The cooling gap increasing in the flow direction of the cooling fluid improves the removal of boiling bubbles from the cooling gap. Even large quantities of boiling bubbles can then be quickly and reliably flushed out with the cooling water. Accordingly, good heat dissipation can be ensured even at higher x-ray power (and thus higher thermal load on the target). This means that the x-ray tube according to the invention can then be operated at a higher power than conventional x-ray tubes.

Due to the fact that the cooling fluid flows from the outside to the inside, the cross-sectional area of the flow path along the flow direction can be kept comparatively small despite the increase in the height of the cooling gap along the flow direction. In contrast, if the flow direction is from the inside to the outside, the cross-sectional area inevitably increases significantly as the height of the flow path increases in the flow direction. Due to the fact that the cross-sectional area along the flow direction can be kept comparatively small, the pressure in the coolant can be kept high, in particular, wherein the pressure in the coolant in the cooling gap remains the same or even increases along the flow direction. This prevents the collapse of boiling bubbles (or the cavitation) in or near the cooling gap. Accordingly, low wear in the anode head is achieved.

The excited region of the target is essentially annular. The cooling gap with the height increasing in the flow direction can then be established in the associated, opposite region of the anode head (i.e., below or behind the excited region) and the boiling bubbles can be easily removed therefrom. A center of the end face of the anode head remains without directly impinging electrons so that it does not heat up as much, and no or at most a few boiling bubbles are generated in adjacent parts of the flow path. Typically, a pin is located opposite the center of the end face (see below).

The local height of the cooling gap can be measured in a direction perpendicular to the target-facing wall of the cooling gap (any micro-waviness of the target-facing wall is neglected). This direction usually corresponds essentially to the axial direction (direction of the central axis of the anode head).

The end face is typically aligned at least essentially perpendicularly to the central axis of the anode head. The central axis and the annular excited region are typically concentric. Typically, the outer shape of the anode head is rotationally symmetric with respect to the central axis, at least in the region of the end face and of a circumferential side wall. The anode head can, in particular, have a substantially circular-cylindrical outer shape.

The region in which the local height of the cooling gap increases from radially outside to radially inside typically comprises at least 15% of the radius of the anode head, preferably at least 20%, particularly preferably at least 25%.

### Preferred Embodiments of the Invention

Preferred is an embodiment of the x-ray tube according to the invention in which a local cross-sectional area of the cooling gap in the region of the anode head opposite the excited region of the target decreases continuously, remains the same, or increases continuously by at most 15% from radially outside to radially inside. By decreasing the cross-sectional area in the cooling gap along the flow direction, the pressure in the cooling fluid can be maintained or increased, in particular, in the region of the cooling gap that is located further radially inside. The mean flow velocity of the cooling fluid then remains the same or increases radially inward in the cooling gap. This counteracts cavitation and reduces macroscopic recirculation. Typically, a decrease in the cross-sectional area is approximately 5-20% in total. Since the volume of the cooling fluid increases along the flow path in the flow direction (i.e., radially inward in the cooling gap) due to boiling bubble formation and thermal expansion, even a constant cross-sectional area or even a slight increase in the cross-sectional area can be acceptable without increased cavitation occurring. The reduced cavitation improves the durability of the x-ray tube. Less recirculation improves the cooling capacity. The local cross-sectional area can be measured as a partial area of a lateral surface of a cone or cylinder, wherein this lateral surface is aligned along a direction perpendicular to the target-facing wall of the cooling gap (any micro-waviness of the target-facing wall is neglected). This direction usually corresponds essentially to the axial direction.

Advantageous is an embodiment in which a local cross-sectional area of the cooling gap in the region of the anode head opposite the excited region of the target decreases continuously from radially outside to radially inside, in particular, decreases continuously by at most 20%. A decreasing cross-sectional area ensures that the pressure in the cooling fluid along the flow path in the region of the cooling gap always increases from the outside to the inside (i.e., even if no or only a few boiling bubbles are formed and/or thermal expansion effects are small), and cavitation is minimized accordingly. If the reduction in cross-sectional area is 20% or less, and the flow velocity of the cooling fluid accordingly does not increase too much, mechanical flushing of material of the anode head is counteracted.

Also preferred is an embodiment in which the flow path in the anode head is at least essentially rotationally symmetric with respect to the central axis. This ensures particularly uniform cooling of the excited region of the target. It should be noted that the flow path is typically not perfectly rotationally symmetric. In particular, a deviation may occur in the region of the outer portion of the flow path due to distribution structures in an otherwise rotationally symmetric, circumferential radial gap, or also at the transitions to the inlet connection or to the outlet connection. In the region of rectification elements, there is typically a rotational symmetry of a certain order (usually a high order, e.g., 8 or higher) with respect to the central axis and, in the region of swirl elements, there may, for example, be a rotational-translational symmetry (e.g., a helical, with the central axis as the helix axis) or again a rotational symmetry of a certain order (usually a high order, e.g., 8 or higher) with respect to the central axis. Such deviations are still considered to be consistent with an essentially rotationally symmetric flow path.

Also advantageous is an embodiment in which the radially outer portion of the flow path is formed at least substantially around the entire circumference of the anode head. This contributes to particularly uniform cooling of the excited region of the target. Preferably, the flow path in the radially outer portion is formed completely around the entire circumference of the anode head.

Particularly preferred is an embodiment in which distribution structures are formed in the radially outer portion of the flow path, with which distribution structures can distribute a cooling fluid flow from the at least one inlet connection to the cooling gap over the circumference of the anode head and make it more uniform. This in turn ensures particularly uniform and efficient cooling of the excited region of the target. The distribution structures can, in particular, be formed by a plurality of axially and azimuthally spaced lamellae or guide plates.

Advantageous is a development of this embodiment which provides that the distribution structures in a subportion of the radially outer portion near the target comprise a set of rectification elements for the cooling fluid, which are distributed over the circumference of the anode head, run between an inlet-side annular gap and an outlet-side annular gap or the cooling gap, and can establish at least essentially parallel partial flows of the cooling fluid and separate them from one another. The rectification elements ensure that a fluid flow flowing locally at the circumference is distributed in the circumferential direction into axial partial flows and cannot continue to flow axially without deflection at its location in the circumferential direction. In particular, a swirl introduced upstream in the fluid flow can be eliminated again in the resulting fluid flow or at least minimized. The (“inlet-side”) annular gap located upstream of the set of rectification elements in the flow direction and, if present, the (“outlet-side”) annular gap following the set of rectification elements in the flow direction each form an equalization zone. The outlet-side annular gap is typically adjoined by the cooling gap. The at least essentially parallel partial flows typically have an intermediate angle of 20° or less, usually 10° or less (with respect to a mean flow direction in each partial flow).

Another advantageous development of the above embodiment provides that the distribution structures in a subportion of the radially outer portion of the flow path far from the target comprise a set of rectification elements for the cooling fluid flow, which are distributed over the circumference of the anode head, run between an inlet-side annular gap and an outlet-side annular gap, and can establish at least essentially parallel partial flows of the cooling fluid and separate them from one another. The rectification elements again ensure that a fluid flow flowing in locally at the circumference is distributed in the circumferential direction into axial partial flows and cannot continue to flow axially without deflection at its location in the circumferential direction. In particular, a swirl introduced upstream in the fluid flow can be eliminated again in the resulting fluid flow or at least minimized. Typically, the at least one inlet connection opens into the inlet-side annular gap to the rectification elements of the subportion far from the target; alternatively, a swirling cooling fluid flow from upstream swirl elements can also flow into the inlet-side annular gap. The at least essentially parallel partial flows typically have an intermediate angle of 20° or less, usually 10° or less (with respect to a mean flow direction in each partial flow).

Also advantageous is a sub-variant in which sets of rectification elements are provided in the radially outer portion of the flow path not only in a subportion near the target but also in a subportion far from the target (or farther from the target), wherein it is provided that the outlet-side annular gap to the rectification elements of the subportion far from the target is at the same time the inlet-side annular gap to the rectification elements of the subportion near the target, and that the set of rectification elements of the subportion near the target is offset relative to the set of rectification elements of the subportion far from the target in the azimuthal direction with respect to the central axis of the anode head. This introduces a minimum deflection into the coolant flow in the central annular gap and ensures particularly good equalization of the cooling capacity in the azimuthal direction.

Also preferred is a sub-variant in which the rectification elements are aligned at least essentially in the axial direction, and the partial flows of the cooling fluid are accordingly aligned at least essentially in the axial direction. This design is structurally simple and reliably minimizes swirl in the cooling fluid. Typically, a deviation from an exact axial alignment is at most 10°, usually at most 5°, or even 0°.

A preferred sub-variant provides that the rectification elements are formed at least in part by: parallel lamellae, in particular, straight parallel lamellae; and/or trapezoidal or triangular lamellae; and/or drop-shaped or diamond-shaped lamellae;

wherein the lamellae are formed on a radially outward-facing wall side and/or a radially inward-facing wall side of the anode head, wherein the radially outward-facing wall side and the radially inward-facing wall side also delimit the radially outer portion of the flow path. These designs have proven effective in practice and are comparatively easy to manufacture.

Also advantageous is a sub-variant in which the rectification elements are formed at least in part by a plurality of parallel hollow structures arranged in the radially outer portion of the flow path, in particular, wherein the plurality of parallel hollow structures forms a honeycomb structure. The hollow structures are structurally easy to establish. A honeycomb structure allows the hollow structures to be packed particularly densely, and a particularly large cross-sectional area can be established for the partial flows.

In an advantageous further development, it is provided that the distribution structures in a subportion of the radially outer portion of the flow path far from the target comprise one or more swirl elements, which are arranged between the at least one inlet connection and an outlet-side annular gap and with which a swirl with respect to the central axis can be introduced into the cooling fluid flow. The swirl of the cooling fluid ensures an even distribution of the cooling fluid (and of the cooling fluid flow) over the circumference of the radially outer part of the flow path. The swirl causes a velocity component of the cooling fluid in the circumferential direction of the anode head so that the cooling fluid rotates about the anode axis. Typically, the subportion far from the target, in which the swirl elements are arranged, is at the same time the subportion of the radially outer part of the flow path furthest from the target.

Preferred is a development of this embodiment in which the at least one swirl element runs helically around the central axis of the anode head, thereby establishing at least one helical channel for the cooling fluid flow. This design has proven effective in practice and can be used well, even with a high coolant flow, to reliably introduce swirl into the coolant flow. A helical swirl element preferably runs at least 0.8 times, particularly preferably at least 1.0 times, especially preferably at least 2.0 times, around the central axis.

In a preferred further development, it is provided that multiple swirl elements run helically around the central axis of the anode head, thereby establishing multiple, azimuthally and/or axially offset helical channels for partial flows of the cooling fluid. Due to multiple helical channels, the coolant flow along the circumference can be divided and be given a swirl in each case, thus contributing to the even distribution of the cooling capacity.

Preferred is a development of the embodiment with distribution structures in the radially outer portion of the flow path, wherein an equalization zone for the cooling fluid flow is established between distribution structures of a subportion of the radially outer portion far from the target and distribution structures of a subportion of the radially outer portion near the target, in particular, wherein the equalization zone is established as an annular gap. In an equalization zone between two (adjacent) subportions, the flow velocity of the cooling fluid can be equalized. In particular, the axial flow velocity downstream of the equalization zone (with respect to the flow direction of the cooling fluid) may have less spread around the circumference than upstream of the equalization zone. Equalization zones can also be provided upstream of distribution structures of a subportion of the radially outer portion of the flow path furthest from the target and/or downstream of distribution structures of a subportion nearest the target.

In a preferred embodiment, the anode head is formed with a first flow element and a second flow element, which are inserted into one another and form at least part of the flow path between them. This is structurally simple and has proven effective in practice.

Particularly preferred is an embodiment in which at least the radially inner portion of the flow path, and optionally also the cooling gap, are partially delimited by a pin, which projects from the end face of the anode head into the interior of the anode head. In other words, the pin projects from a target-facing wall of the flow path into the flow path in the interior of the anode head into the radially inner portion. The pin is typically located on the central axis. The pin prevents a direct collision (in the radial flow direction) of the cooling fluid converging from different radial directions in the transition region between the cooling gap and the radially inner portion of the flow path. The pin can be used to deflect the cooling fluid, in particular, in the axial direction, and the flow of the cooling fluid can, in particular, be made approximately parallel. In addition, the pressure profile and flow velocity in the cooling fluid can be maintained or moderated with the pin.

The scope of the present invention also includes an x-ray tube arrangement, comprising an x-ray tube according to the invention as described above and a supply device for a cooling fluid, wherein the supply device provides fresh cooling fluid at a discharge outlet and the discharge outlet is connected to the at least one inlet connection, in particular, wherein the supply device continues to receive heated cooling fluid at a return inlet and the outlet connection is connected to the return inlet. The supply device provides the cooling fluid and typically also conveys (e.g., pumps) it, and the cooling fluid flow in the anode head is set from radially outside to radially inside. The x-ray tube ensures particularly good cooling.

The scope of the present invention also includes the use of an x-ray tube according to the invention as described above or of an x-ray tube arrangement according to the invention as described above, wherein, during operation of the x-ray tube: electrons from the source for releasing electrons impinge on an annular, excited region of the target, thereby generating x-ray radiation; and cooling fluid flows from radially outside to radially inside in the cooling gap opposite the excited region. The cooling by the cooling fluid in the cooling gap is highly efficient. Boiling bubbles can contribute to the absorption of heat and are easily transported away through the cooling gap, which becomes higher in the flow direction. At the same time, cavitation can be kept low.

In a preferred variant of the use according to the invention, it is provided that a mean flow velocity of the cooling fluid in the cooling gap opposite the excited region remains the same or increases from radially outside to radially inside, in particular, increases by at most 25%. The increasing flow velocity ensures that the pressure in the cooling fluid does not decrease and cavitation remains particularly low. Accordingly, wear on the anode head is also low.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1 shows a schematic longitudinal section through an exemplary embodiment of an x-ray tube according to the invention;

FIG. 2a shows a schematic longitudinal section through an exemplary anode head according to a first design for the invention, with swirl elements in a lower subportion of a radially outer portion of the flow path far from the target and rectification elements in an upper subportion near the target;

FIG. 2b shows a schematic cross-section through the anode head of FIG. 2a, on the plane B-B of FIG. 2a;

FIG. 2c shows a schematic cross-section through the anode head of FIG. 2a, on the plane C-C of FIG. 2a;

FIG. 2d shows a schematic plan view of the anode head of FIG. 2a;

FIG. 2e shows a schematic, semi-open perspective view of the anode head of FIG. 2a, with an inner flow element;

FIG. 2f shows a schematic, semi-open perspective view of the anode head of FIG. 2a, without an inner flow element;

FIG. 2g shows an enlargement of the anode head of FIG. 2a in the region near the end face;

FIG. 3a shows a schematic longitudinal section through an exemplary anode head according to a second design for the invention, with rectification elements in a lower subportion of a radially outer portion of the flow path far from the target and rectification elements in an upper subportion near the target;

FIG. 3b shows a schematic cross-section through the anode head of FIG. 3a, on the plane B-B of FIG. 3a;

FIG. 3c shows a schematic cross-section through the anode head of FIG. 3a, on the plane C-C of FIG. 3a;

FIG. 3d shows a schematic cross-section through the anode head of FIG. 3a, on the plane D-D of FIG. 3a;

FIG. 3e shows a schematic, semi-open perspective view of the anode head of FIG. 3a, with an inner flow element;

FIG. 3f shows a schematic, semi-open perspective view of the anode head of FIG. 3a, without an inner flow element;

FIG. 3g shows an enlargement of the anode head of FIG. 3a in the region near the end face;

FIG. 4a shows a schematic longitudinal section through an exemplary anode head according to a third design for the invention, with swirl elements in a lower subportion of a radially outer portion of the flow path far from the target, rectification elements in a central subportion far from the target, and rectification elements in an upper subportion near the target;

FIG. 4b shows a schematic cross-section through the anode head of FIG. 4a, on the plane B-B of FIG. 4a;

FIG. 4c shows a schematic cross-section through the anode head of FIG. 4a, on the plane C-C of FIG. 4a;

FIG. 4d shows a schematic cross-section through the anode head of FIG. 4a, on the plane D-D of FIG. 4a;

FIG. 4e shows a schematic, semi-open perspective view of the anode head of FIG. 4a, with an inner flow element;

FIG. 4f shows a schematic, semi-open perspective view of the anode head of FIG. 4a, without an inner flow element;

FIG. 4g shows an enlargement of the anode head of FIG. 4a in the region near the end face;

FIG. 5 shows a schematic, semi-open side view of an anode head for the invention in the region of the radially outer portion of the flow path, with helical swirl elements and drop-shaped rectification elements;

FIG. 6 shows a schematic, semi-open side view of an anode head for the invention in the region of the radially outer portion of the flow path, with swirl elements designed as oblique lamellae and trapezoidal rectification elements;

FIG. 7 shows a schematic, semi-open side view of an anode head for the invention in the region of the radially outer portion of the flow path, with hollow structures as rectification elements and trapezoidal rectification elements.

### DETAILED DESCRIPTION OF THE PREFERRED EMBODIMENTS

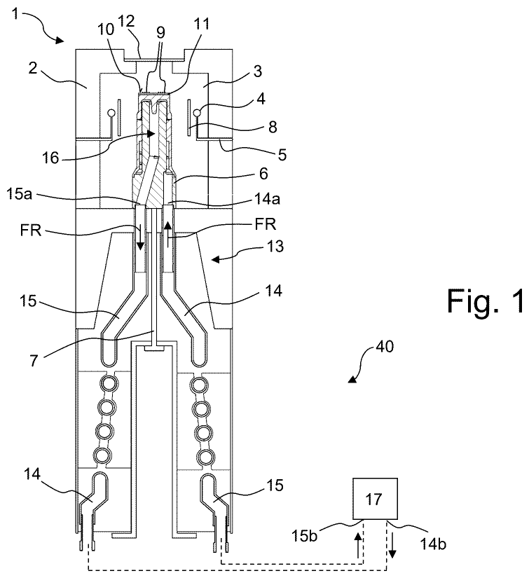

FIG. 1 shows a schematic longitudinal section of an exemplary embodiment of an x-ray tube 1 according to the invention.

In its upper part in FIG. 1, a housing 2 (also called cathode housing) encloses an evacuated chamber 3. In the evacuated chamber 3, a source 4 for releasing electrons is arranged, the source here being formed by an annular filament. The filament can be heated with an electric current via the connections 5. An anode head 6 also projects into the evacuated chamber 3.

Via the connections 5, the source 4 is brought to a negative electrical potential (compared to the anode head 6), i.e., it is connected as a cathode. The anode head 6 is brought to a positive electrical potential (compared to the source 4) via an electrical connection 7, i.e., it is connected as an anode. Electrons released at the source 4 are then accelerated through the evacuated chamber 3 toward the anode head 6 due to the potential difference between the source 4 and the anode head 6. Typically, the potential difference (also called acceleration voltage) is between 1 kV and 100 kV.

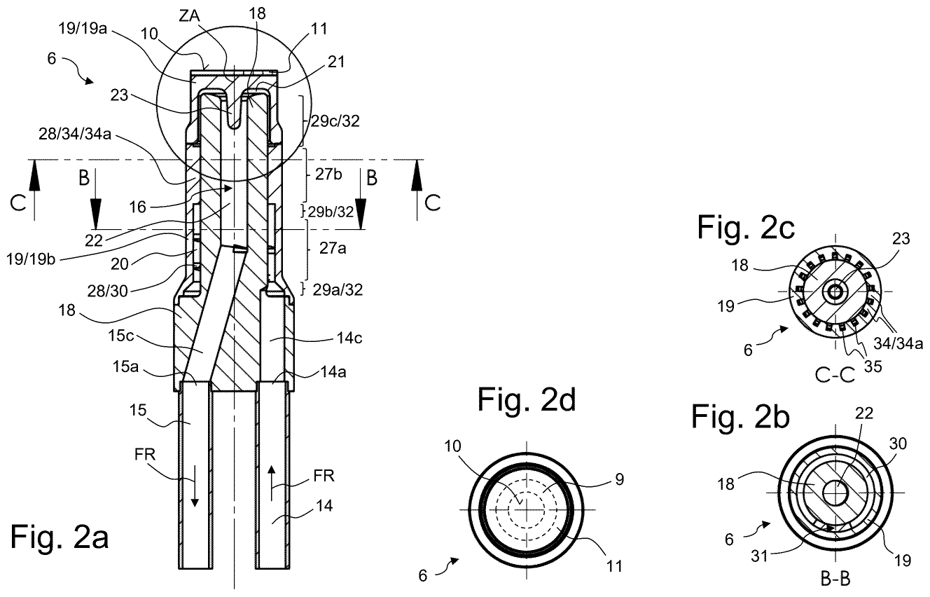

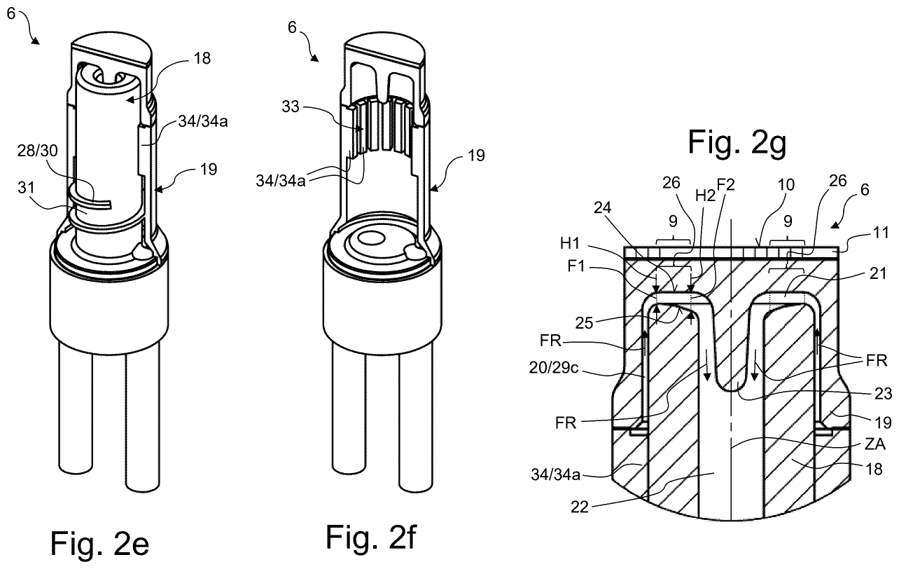

By means of suitably arranged deflection electrodes 8 at a suitable potential, the trajectory of the electrons is set up such that the electrons impinge on the end face 10 of the anode head 6 in an annular region 9 (indicated by dots in FIG. 1, see also FIG. 2d). A target 11 is formed on the end face 10 of the anode head 6. The target 11 here consists of an applied disk made of rhodium (or, alternatively, for example, copper, molybdenum, chromium, or silver, depending on the desired characteristic x-ray radiation), which here extends over the entire surface of the end face 10, which is flat here.

The electrons impinging on the target 11 in the annular, excited region 9 penetrate into the material of the target 11 and are slowed down in the process. This produces x-ray radiation in the form of bremsstrahlung. In addition, electrons are dislodged from the electron shells of the atoms of the material of the target 11. When these electron shells are refilled with electrons from higher shells, characteristic x-ray radiation is produced. The x-ray radiation thus generated at the target 11 largely exits through an x-ray window 12 of the housing 2 and is then used for an application, for example an x-ray fluorescence experiment (application not shown in detail). The x-ray window 12 here is formed by a beryllium disk.

The housing 2 and the anode head 6 here are arranged on an insulating body 13. The insulating body 13 can, for example, be designed as in EP 4 141 905 A1.

The electrons impinging on the target 11 during operation cause the anode head 6 to heat up considerably. The anode head 6 is therefore actively cooled with a cooling fluid. The cooling fluid may, for example, be water.

An inlet line 14 for fresh (cool) cooling fluid leads through the insulating body 13 to an inlet connection 14a of the anode head 6. Furthermore, an outlet line 15 for used (heated) cooling fluid runs from an outlet connection 15a of the anode head 6 through the insulating body 13. Within the anode head 6, a flow path 16 for the cooling fluid leads from the inlet connection 14a to the outlet connection 15a (for the flow path 16, see, in particular, FIGS. 2a-2g below).

The x-ray tube 1 is connected to a supply device 17 for cooling fluid. At a discharge outlet 14b, fresh cooling fluid is discharged from the supply device 17 and fed into the anode head 6 via the inlet line 14. Heated cooling fluid flows from the anode head 6 via the outlet line 15 to the return inlet 15b of the supply device 17. The supply device 17 may comprise a cooling unit and a pump for the cooling fluid (not shown in detail). The entirety of x-ray tube 1 and connected supply device 17 for cooling fluid is also referred to as x-ray tube arrangement 40.

FIGS. 2a to 2g illustrate an exemplary anode head 6 in a first design for the invention. FIG. 2a shows a longitudinal section, and FIGS. 2b and 2c show cross-sections on the planes B-B and C-C. FIG. 2d is a plan view of the end face 10 of the anode head 6. FIGS. 2e and 2f show semi-open perspective views of the anode head 6, with an inner flow element 18 (FIG. 2e) and without an inner flow element (FIG. 2f). Finally, FIG. 2g shows an enlargement of the longitudinal section of FIG. 2a in the region near the end face 10 of the anode head 6.

The anode head 6 of FIGS. 2a-2g corresponds to the anode head of FIG. 1 (see also there). In addition, parts of the inlet line 14 and of the outlet line 15 for the coolant are also illustrated, see FIGS. 2a, 2e, 2f. The coolant flows along the flow direction FR. In the plan view of FIG. 2d, the excited, annular region 9 (boundary shown in dashed lines) of the target 11 can also be clearly seen. The target 11 here is perpendicular to the central axis ZA of the anode head 6. The anode head 6 is essentially circular-cylindrical overall, here with two small, circumferential shoulders.

In the embodiment shown, the anode head 6 is formed by a first, inner flow element (or sub-component) 18 and a second, outer flow element (or sub-component) 19. The flow elements 18, 19 are pushed into each other along a central axis ZA of the anode head 6. The second, outer flow element 19 here comprises a cap 19a, which sits on a base 19b and is soldered or welded thereto. The flow path 16 for the cooling fluid is formed within the inner flow element 18 and between the flow elements 18, 19. The flow path 16 runs from the inlet connection 14a via an inlet channel 14c (here running axially but eccentrically), a radially outer portion 20, a cooling gap 21, a radially inner portion 22 (here running axially and centrally), and an outlet channel 15c (here inclined relative to the central axis) to the outlet connection 15a.

The radially outer portion 20 runs between the radially outer side of the inner flow element 18 and the radially inner side of the outer flow element 19. The cooling gap 21 is located behind the target 11 and opposite the annular excited region 9 of the target 11 (clearly visible in FIG. 2g). The cooling gap 21 is limited at the top by the outer flow element 19 and at the bottom by the inner flow element 18. The cooling gap 21 runs essentially transversely to the central axis ZA. A pin 23 of the outer flow element 19 projects into the radially inner portion 22 in an upper part so that the radially inner portion 22 is delimited in this upper part by the outer flow element 19 and the inner flow element 18. In a lower part of the radially inner portion 22 of the flow path 16, only the radially inner flow element 18 delimits the radially inner portion 22. The axial, radially inner portion 22 transitions into the outlet channel 15c, which is oblique here.

The cooling fluid flows axially upward in the flow path 16 along the radially outer portion, from radially outside to radially inside in the region of the cooling gap 21, and axially downward in the region of the radially inner portion 22.

As can be clearly seen in FIG. 2g, in the design shown, the upper, target-facing wall 24 of the cooling gap 21 is perpendicular to the central axis ZA. The lower wall 25 of the cooling gap 21 facing away from the target runs straight here, but with a slight slope with respect to the direction perpendicular to the central axis, wherein the wall 25 facing away from the target slopes downward radially inward. In a region 26 opposite the annular, excited region 9 of the target 11, a height of the cooling gap 21 (measured in a direction perpendicular to the target-facing wall 24, i.e., measured here in the axial direction) increases continuously from radially outside to radially inside (i.e., along the flow direction FR in the cooling gap 21). By way of example, a first height H1 is shown further radially outside and a second height H2 is shown further radially inside, each at the edge of the region 26. The height of the cooling gap 21 increasing along the flow direction FR facilitates the removal of boiling bubbles from the cooling gap 21 into the radially inner portion 22 (and thus also out of the anode head 6 as a whole). The region 26, in which the height of the cooling channel 21 increases continuously, extends here over approximately 30% of the radius of the anode head 6 (at the axial position of the cooling gap 21).

In addition, in the region 26, the cross-sectional area available to the cooling fluid in the cooling gap 21 also changes along the flow direction FR, i.e., from radially outside to radially inside. The cross-sectional area here corresponds to a lateral cylinder surface in the cooling gap 21, which surface is located, perpendicular to the upper, target-facing wall 24, at the corresponding radial position. By way of example, a first surface F1 further radially outside and a second surface F2 further radially inside are marked with dots, in each case at the edge of the region 26. It should be noted that the cross-sectional area is calculated as the product of the circumference of the circle and the height of the cooling gap at the corresponding radial position. In the embodiment shown, the cross-sectional area decreases slightly from radially outside to radially inside, wherein approximately F2=0.8*F1 here (it should be noted that the radius in FIG. 2g decreases faster toward the inside than the height of the cooling gap increases; the cross-sectional area therefore decreases radially inward even though the height increases). The decreasing cross-sectional area in the cooling gap 21 in the flow direction FR ensures that the pressure in the cooling fluid in the cooling gap 21 increases slightly radially inward; this prevents collapse of the boiling bubbles (cavitation).

By means of the pin 23, the fluid flow of the cooling fluid, which flows radially inward from the cooling gap 21, is deflected axially downward. The partial flows of the cooling fluid coming from different azimuthal positions flow, after being deflected by the pin 23, essentially parallel to one another along the axial direction until, at the lower end of the pin with respect to the radial direction, they are finally united. This ensures efficient flow of the cooling fluid.

In the design shown, the radially outer portion 20 comprises two subportions 27a, 27b, in each of which distribution structures 28 for the cooling fluid are formed. In the flow direction FR, annular gaps 29a, 29b, 29c (also referred to as annular channels) are arranged upstream of, between and downstream of the subportions 27a, 27b. In the annular gaps, the cooling fluid can spread over the entire circumference here; no distribution structures are arranged in the annular gaps. With the distribution structures 28 in the subportions 27a, 27b and the annular gaps 29a-29c acting as equalization zones 32, the cooling fluid, which here flows into the anode head 6 via a single inlet connection 14a and inlet channel 14c, is distributed over the circumference of the anode head 6 so that an substantially equal coolant flow in the axial direction is achieved at all circumferential positions directly upstream of the cooling gap 21.

The inlet channel 14c, which is formed near the right-hand edge in the lower part of the anode head 6 in FIG. 2a, opens into the lower annular gap 29a. Said lower annular gap here runs around the entire circumference of the anode head 6. The lower annular gap 29a acts as an equalization zone 32 and does not contain any distribution structures.

The lower annular gap 29a is adjoined by the subportion 27a that is far from the target. In this embodiment, a helical swirl element 30 is provided as the first distribution structure 28 that is far from the target, which swirl element here is formed on the radially outer side of the inner flow element 18, as can be clearly seen in FIG. 2e. The helical swirl element 30 here winds approximately twice around the central axis ZA. The helical swirl element 30 extends to the radially inner side of the outer flow element 19 so that a helical channel 31 is formed in the subportion 27a that is far from the target (in the radial gap between the flow elements 18, 19). When flowing through the helical channel 31, the cooling fluid receives a velocity component in the circumferential direction about the central axis ZA.

The helical channel 31 opens into the central annular gap 29b. The annular gap 29b here also runs around the entire circumference of the anode head 6. The central annular gap 29b also acts as an equalization zone 32 and does not contain any distribution structures. The swirl introduced into the cooling fluid distributes the cooling fluid flow in the annular gap 29b very evenly over the entire circumference of the anode head 6.

The central annular gap 29b is adjoined by the subportion 27b that is near the target. In the subportion 27b that is near the target (in the radial gap between the flow elements 18, 19), a set 33 of rectification elements 34 is provided. The rectification elements 34 here are designed as straight lamellae 34a running parallel to the central axis ZA. The straight lamellae 34a here are formed as radially inward-facing projections on the radially inner side of the outer flow element 19, as can be clearly seen in FIG. 2f. The rectification elements 34 remove the swirl from the cooling fluid. In the portion 27 that is near the target, the coolant flows axially upward in the intermediate spaces 35 between the lamellae 34a.

The subportion 27b that is near the target is adjoined by the upper annular gap 29c. The intermediate spaces 35 open into this annular gap 29c. The annular gap 29c here also runs around the entire circumference of the anode head 6. This annular gap 29c also acts as an equalization zone 32 and does not contain any distribution structures.

At its upper end, the upper annular gap 29c transitions into the cooling gap 21. The distribution structures 28 in the portions 27a, 27b in interaction with the equalization zones 32 (annular gaps 29a, 29b, 29c) ensure that cooling fluid flows from all locations along the circumference of the anode head 6 radially inward into the cooling gap 21 and through the cooling gap 21 at approximately the same speed. This ensures uniform cooling of the anode head 6, in particular, in the (radial) region 26, which is located opposite the excited region 9 of the target 11 and near the target 11.

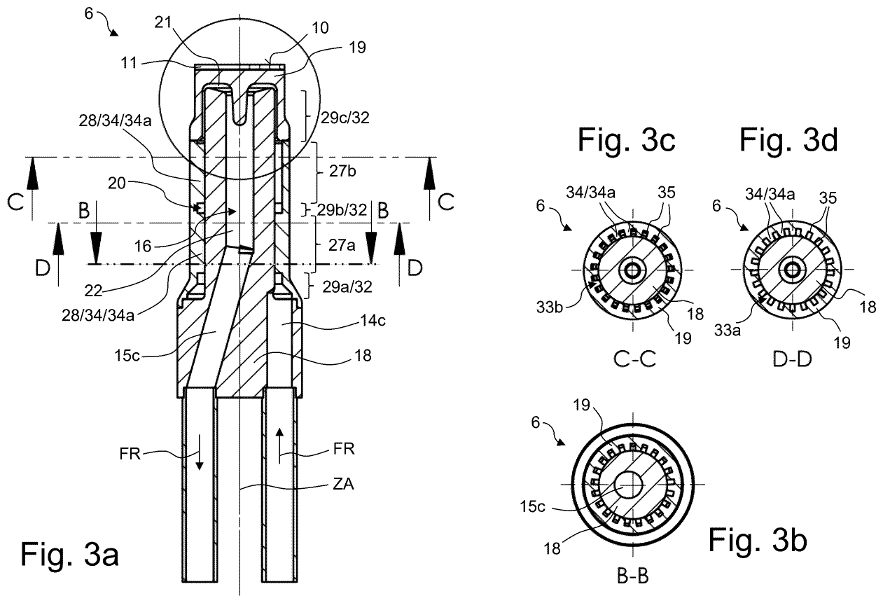

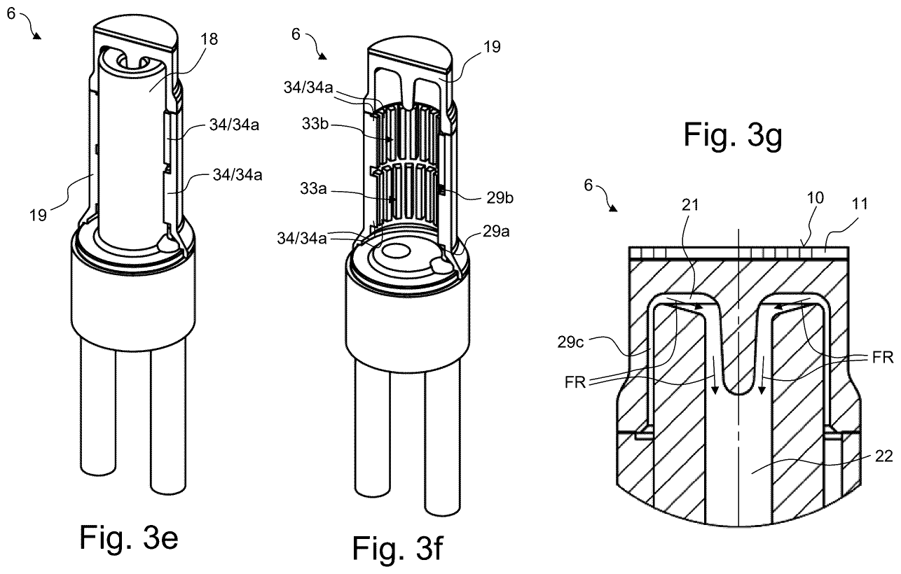

FIGS. 3a to 3g illustrate an exemplary anode head 6 in a second design for the invention. FIG. 3a shows a longitudinal section, and FIGS. 3b, 3c, and 3d show cross-sections on the planes B-B, C-C, and D-D, respectively. FIGS. 3e and 3f are semi-open perspective views of the anode head 6, with and without an inner flow element 18, respectively. Finally, FIG. 3g shows an enlargement from the longitudinal section of FIG. 3a in the region near the end face 10 of the anode head 6. The second design is largely similar to the first design in FIGS. 2a-2g (in particular, with respect to the cooling channel 21 and the radially inner portion 22 of the flow path 16) so that only the essential differences (in particular, in the region of the radially outer portion 20 of the flow path 16) are explained below.

The lower annular gap 29a is adjoined by the subportion 27a that is far from the target. In this subportion, a first set 33a of rectification elements 34 is provided. The rectification elements 34 here are designed as straight lamellae 34a running parallel to the central axis ZA. The straight lamellae 34a here are formed as radially inward-facing projections on the radially inner side of the outer flow element 19. In the portion 27b that is near the target, the cooling fluid flows axially upward in the intermediate spaces 35 between the lamellae 34a.

The lower subportion 27a that is far from the target is adjoined by the central annular gap 29b. The annular gap 29b here also runs around the entire circumference of the anode head 6. The central annular gap 29b acts as an equalization zone 32.

The central annular gap 29b is in turn adjoined by the subportion 27b that is near the target. In this subportion, a second set 33b of rectification elements 34 is provided. The rectification elements 34 here are also designed as straight lamellae 34a running parallel to the central axis ZA. The straight lamellae 34a here are formed as radially inward-facing projections on the radial inner side of the outer flow element 19, as can be clearly seen in FIG. 3f. In the portion 27b that is near the target, the cooling fluid flows axially upward in the intermediate spaces 35 between the lamellae 34a.

The second set 33b of rectification elements 34 here is arranged offset in the azimuthal direction relative to the first set 33a of rectification elements 34, as can be clearly seen in FIG. 3c and FIG. 3d. At the azimuthal location of each lamella 34a in the first set 33a, there is an aligned intermediate space 35 in the second set 33b, and vice versa. This ensures that a partial flow of cooling fluid from an intermediate space 35 in the first set 33a cannot continue in a straight (axial) direction into an intermediate space 35 of the second set 33b, but must be deflected transversely thereto. This transverse deflection is further facilitated by the central annular gap 29b.

The subportion 27b that is near the target is adjoined by the upper annular gap 29c. The intermediate spaces 35 of the second set 33b open into this annular gap 29c. The annular gap 29c here also runs around the entire circumference of the anode head 6. This annular gap 29c also acts as an equalization zone 32.

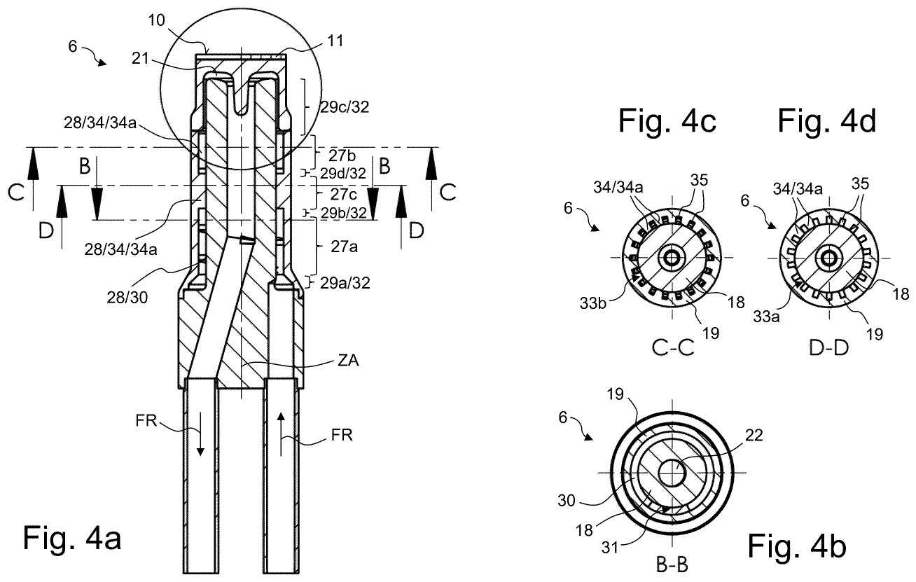

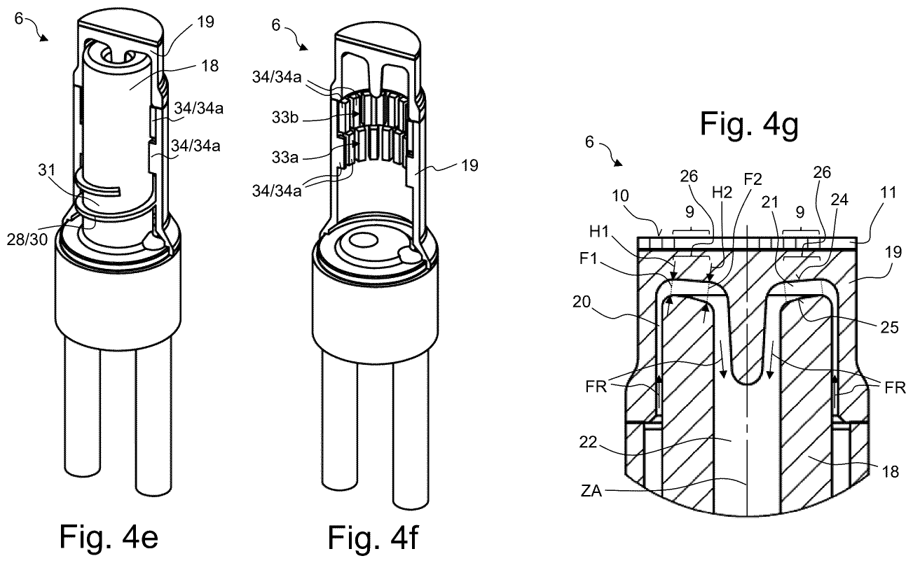

FIGS. 4a to 4g illustrate an exemplary anode head 6 in a third design for the invention. FIG. 4a shows a longitudinal section, and FIGS. 4b, 4c, and 4d show cross-sections on the planes B-B, C-C, and D-D, respectively. FIGS. 4e and 4f are semi-open perspective views of the anode head 6, with and without an inner flow element 18, respectively. Finally, FIG. 4g shows an enlargement of the longitudinal section of FIG. 4a in the region near the end face 10 of the anode head 6. The third design is largely similar to the first design in FIGS. 2a-2g so that only the essential differences are explained below.

In the design in FIGS. 4a-4f, the radially outer portion 20 of the flow path 16 comprises three subportions: namely, the lower subportion 27a that is far from the target (and furthest from the target), a central subportion 27c that is also far from the target, and an upper subportion 27b that is near the target. Upstream of the subportion 27a, downstream of the subportion 27b, and between the subportions 27a, 27c, 27b, there are annular gaps 29a, 29b, 29c, 29d, each of which simultaneously represents equalization zones 32.

The design of the lower annular gap 29a, of the lower subportion 27a that is far from the target with a helical swirl element 30 as distribution structure 28, and of the adjoining central annular gap 29b corresponds to the design in FIGS. 2a-2g.

The central annular gap 29b is adjoined by the central subportion 27c. Since this central subportion 27c is not the subportion that is nearest the target 11 in the axial direction, it is also considered to be far from the target.

In the central subportion 27c here, a first set 33a of rectification elements 34 is provided. The rectification elements 34 here are designed as straight lamellae 34a running parallel to the central axis ZA. The straight lamellae 34a here are formed as radially inward-facing projections on the radial inner side of the outer flow element 19, as can be clearly seen in FIG. 4f. In the central subportion 27c, the coolant flows axially upward in the intermediate spaces 35 between the lamellae 34a.

The central subportion 27c is adjoined by the further, central annular gap 29d. The annular gap 29d here also runs around the entire circumference of the anode head 6. The annular gap 29d acts as an equalization zone 32.

The central annular gap 29d is adjoined by the subportion 27b near the target. In this subportion, a second set 33b of rectification elements 34 is provided. The rectification elements 34 here are also designed as straight lamellae 34a running parallel to the central axis ZA. The straight lamellae 34a here are formed as radially inward-facing projections on the radially inner side of the outer flow element 19, as can be clearly seen in FIG. 4f. In the subportion 27b near the target, the cooling fluid flows axially upward in the intermediate spaces 35 between the lamellae 34a.

The second set 33b of rectification elements 34 here is again arranged offset in the azimuthal direction relative to the first set 33a of rectification elements 34, as can be clearly seen in FIG. 4c and FIG. 4d. At the azimuthal location of each lamella 34a in the first set 33a, there is an aligned intermediate space 35 in the second set 33b, and vice versa. This ensures that a partial flow from an intermediate space 35 in the first set 33a cannot continue in a straight (axial) direction into an intermediate space 35 of the second set 33b, but must be deflected transversely thereto. This transverse deflection is further facilitated by the central annular gap 29 d. It should be noted that the lamellae 34a and the intermediate spaces 35 may have different widths in the azimuthal direction.

The subportion 27b that is near the target is adjoined by the upper annular gap 29c. The intermediate spaces 35 of the second set 33b open into this annular gap 29c. The annular gap 29c here also runs around the entire circumference of the anode head 6. This annular gap 29c also acts as an equalization zone 32.

As can be clearly seen in FIG. 4g, in the embodiment shown, the upper, target-facing wall 24 of the cooling gap 21 here is aligned with a slight slope to a direction perpendicular to the central axis ZA, wherein the target-facing wall 24 slopes downward radially inward. The lower wall 25 of the cooling gap 21 facing away from the target runs approximately straight with a somewhat steeper slope with respect to the direction perpendicular to the central axis ZA, wherein the wall 25 facing away from the target also slopes downward radially inward. In a region 26 opposite the annular, excited region 9 of the target 11, a height of the cooling gap 21 (measured in a direction perpendicular to the target-facing wall 24, i.e., in a direction slightly oblique to the central axis ZA) increases from radially outside to radially inside (i.e., along the flow direction FR in the cooling gap 21). By way of example, a first height H1 is shown further radially outside and a second height H2 is shown further radially inside, in each case at the edge of the region 26. This facilitates the removal of boiling bubbles from the cooling gap 21 into the radially inner portion 22.

In addition, in the region 26, the cross-sectional area available to the coolant in the cooling gap 21 also changes along the flow direction FR, i.e., from radially outside to radially inside. The cross-sectional area here corresponds to a lateral conical surface in the cooling gap 21, which surface is located, perpendicular to the upper, target-facing wall 24, at the corresponding radial position. By way of example, a first surface F1 further radially outside and a second surface F2 further radially inside are marked with dots, in each case at the edge of the region 26. In this design, the cross-sectional area also decreases from radially outside to inside, i.e., F2<F1. The decreasing cross-sectional area in the cooling gap 21 in the flow direction FR ensures that the pressure in the cooling fluid increases slightly radially inward; this prevents collapse of the boiling bubbles (cavitation).

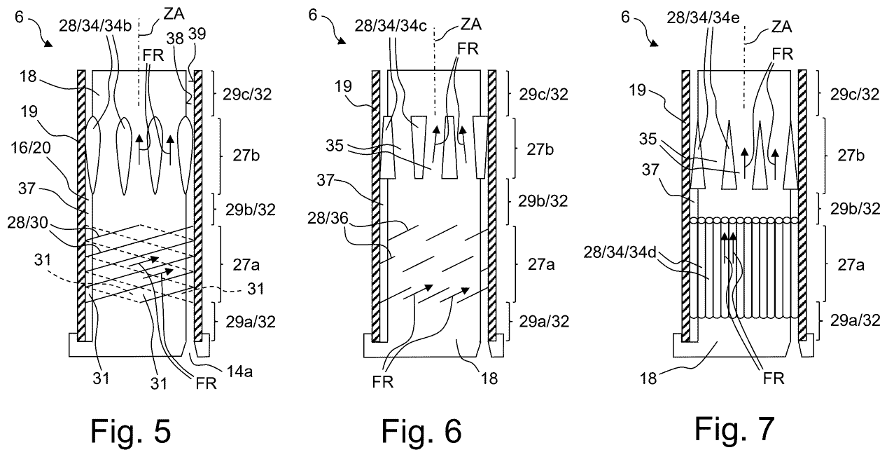

FIG. 5 illustrates a further exemplary design of an anode head 6 for the invention. Only a part of the anode head 6 is shown in a highly schematic side view, which includes the radially outer portion of the flow path 16. The radially outer flow element 19 is cut open and removed on the side toward the observer so that the observer can see the inner flow element 18 and the distribution structures 28 in the radially outer portion 20 of the flow path 16 (“semi-open” anode head 6). The essential differences in comparison to the design in FIGS. 2a-2g are explained.

In the lower portion 27a far from the target, a total of four helical swirl elements 30 are provided here (helical swirl elements 30 on the rear side of the radially inner flow element 18 are shown in dashed lines), which establish a total of four helical channels 31.

In the upper portion 27b that is near the target, the rectification elements 34 here are provided as drop-shaped lamellae 34b. These lamellae are all aligned axially (along the central axis ZA). The lamellae 34b here are formed on the radially outward-facing wall side 38 of the inner flow element 18 and project into the radial gap 37 between this wall side 38 and the radially inward-facing wall side 39 of the radially outer flow element 19. Alternatively, the lamellae 34b can also be formed on the wall side 39 (not shown in detail, but see, for example, FIG. 2f). The radial gap 37 essentially forms the radially outer portion 20 of the flow path 16.

FIG. 6 shows a further exemplary design of an anode head 6 for the invention, again in a semi-open representation as explained with regard to FIG. 5. The essential differences in comparison to the design in FIGS. 2a-2g are explained.

In the lower portion 27a that is far from the target, a plurality of swirl elements 36 is provided, which are each designed as individual lamellae arranged obliquely to the central axis ZA. All swirl elements 36 have the same inclination (“slope”) to the central axis ZA and here are arranged distributed in the circumferential direction and also in the axial direction in the portion 27a on the outer side of the radially inner flow element 18. It should be noted that, in other designs, subsets of the swirl elements can also be inclined differently (not shown in detail). Each individual lamella here covers only a small part of the circumference (e.g., 1/10 or less of the circumference). The individual lamellae here are spaced radially and axially from one another.

In the upper portion 27b that is near the target, the rectification elements 34 here are provided as trapezoidal lamellae 34c. The trapezoidal lamellae 34c are all aligned axially (along the central axis ZA). However, the orientation of the trapezoidal lamellae 34c alternates here so that the thin ends are arranged alternately at the top and bottom. As a result, the intermediate spaces 35 between the lamellae each have a slight inclination relative to the central axis ZA, wherein these inclinations also alternate in their direction along the circumferential direction. Accordingly, the partial flows of the cooling fluid in adjacent intermediate spaces 35 are also slightly inclined relative to one another (with respect to their mean flow direction, see also the flow directions FR). This can contribute to better equalization of the partial flows of the cooling fluid.

FIG. 7 shows a further exemplary design of an anode head 6, again in a semi-open representation as explained with regard to FIG. 5. The essential differences in comparison to the design in FIGS. 3a-3g are explained.

In the lower portion 27a that is far from the target, a plurality of rectification elements 34 is provided here, which are designed as hollow structures 34d in the form of tubes which are round here. Here, the tubes are all aligned parallel to the central axis ZA. The tubes here completely fill the radial gap 37 between the inner flow element 18 and the outer flow element 19, here with a single layer of the round tubes or hollow structures 34d; residual spaces (“triangular gaps”) are filled with a resin (not shown in detail). Alternatively, the hollow structures 34d can also be honeycomb-shaped, for example, and typically fill the gap 37 with multiple layers of honeycombs (not shown in detail).

In the upper portion 27b that is near the target, the rectification elements 34 here are designed as triangular lamellae 34e. The triangular lamellae 34e are all aligned axially (along the central axis ZA), with the tips upward. Accordingly, the intermediate spaces 35 are narrower at the bottom than at the top. This allows the pressure in the annular gap 29b upstream thereof to be kept high, which improves the equalization of the cooling fluid flow.

List of reference signs:
1 X-ray tube
2 Housing
3 Evacuated chamber
4 Source for releasing electrons, here filament
5 Electrical connections (of the cathode)
6 Anode head
7 Electrical connection (of the anode)
8 Deflection electrodes
9 (Annular) excited region
10 End face of the anode head
11 Target
12 X-ray window, here beryllium disk
13 Insulating body
14 Inlet line for cooling fluid
14a Inlet connection of the anode head
14b Discharge outlet
14c Inlet channel
15 Outlet line for cooling fluid
15a Outlet connection of the anode head
15b Return inlet
15c Outlet channel
16 Flow path
17 Supply device for cooling fluid
18 Inner (first) flow element
19 Outer (second) flow element
19a Cap of the outer flow element
19b Base of the outer flow element
20 Radially outer portion of the flow path
21 Cooling gap
22 Radially inner portion of the flow path
23 Pin
24 Target-facing wall of the cooling gap
25 Wall of the cooling gap facing away from the target
26 Region of the anode head opposite the excited region of the target
27a (Lower) subportion far from the target
27b (Upper) subportion that is near the target
27c (Central) subportion that is far from the target
28 Distribution structures (in general)
29a-d Annular gap
30 Helical swirl element
31 Helical canal
32 Equalization zone
33 Set of rectification elements
33a First set of rectification elements
33b Second set of rectification elements
34 Rectification elements (in general)
34a Straight lamellae
34b Drop-shaped lamellae
34c Trapezoidal lamellae
34d Hollow structures (here round tubes)
34e Triangular lamellae
35 Intermediate spaces
36 Swirl element (obliquely arranged individual lamella)
37 Radial gap
38 Radially outward-facing wall side (on the inner flow element)
39 Radially inward-facing wall side (on the outer flow element)
40 X-ray tube arrangement
FR Flow direction
ZA Central axis

What is claimed is:

1. An X-ray tube, comprising:
a source for releasing electrons and an anode head with a central axis;
wherein a target is formed on an end face of the anode head, on which target the electrons impinge in an excited region during operation;
wherein the anode head provides a flow path for a cooling fluid, which flow path leads from at least one inlet connection via a radially outer portion, further via a cooling gap, and further via a radially inner portion to at least one outlet connection;
wherein the excited region of the target is essentially annular, and in that, in a region of the anode head opposite the excited region of the target, a local height of the cooling gap increases continuously from radially outside to radially inside.

2. The X-ray tube according to claim 1, wherein a local cross-sectional area of the cooling gap in the region of the anode head opposite the excited region of the target decreases continuously, remains the same, or increases continuously by at most 15% from radially outside to radially inside.

3. The X-ray tube according to claim 1, wherein a local cross-sectional area of the cooling gap in the region of the anode head opposite the excited region of the target decreases continuously from radially outside to radially inside.

4. The X-ray tube according to claim 1, wherein the flow path in the anode head is at least substantially rotationally symmetric with respect to the central axis.

5. The X-ray tube according to claim 1, wherein the radially outer portion of the flow path is formed at least substantially around the entire circumference of the anode head.

6. The X-ray tube according to claim 1, wherein distribution structures are formed in the radially outer portion of the flow path, the distribution structures configured where a cooling fluid flow from the at least one inlet connection to the cooling gap is distributed over the circumference of the anode head and made more uniform.

7. The X-ray tube according to claim 6, wherein the distribution structures in a subportion of the radially outer portion near the target comprise a set of rectification elements for the cooling fluid, which are distributed over the circumference of the anode head, run between an inlet-side annular gap and an outlet-side annular gap or the cooling gap, and are configured to establish at least essentially parallel partial flows of the cooling fluid and separate them from one another.

8. The X-ray tube according to claim 6, wherein the distribution structures in a subportion of the radially outer portion of the flow path far from the target comprise a set of rectification elements for the cooling fluid flow, which are distributed over the circumference of the anode head, run between an inlet-side annular gap and an outlet-side annular gap, and are configured to establish at least essentially parallel partial flows of the cooling fluid and separate them from one another.

9. The X-ray tube according to claim 7, wherein the distribution structures in a subportion of the radially outer portion of the flow path far from the target comprise a set of rectification elements for the cooling fluid flow, which are distributed over the circumference of the anode head, run between an inlet-side annular gap and an outlet-side annular gap, and are configured to establish at least essentially parallel partial flows of the cooling fluid and separate them from one another, and wherein the outlet-side annular gap to the rectification elements of the subportion far from the target is at the same time the inlet-side annular gap to the rectification elements of the subportion near the target, and in that the set of rectification elements of the subportion near the target is offset relative to the set of rectification elements of the subportion far from the target in the azimuthal direction with respect to the central axis.

10. The X-ray tube according to claim 7, wherein the rectification elements are aligned at least essentially in the axial direction, and the partial flows of the cooling fluid are accordingly aligned at least essentially in the axial direction.

11. The X-ray tube according to claim 7, wherein the rectification elements are formed at least in part by parallel lamellae, being straight parallel lamellae, and/or trapezoidal or triangular lamellae, and/or drop-shaped or diamond-shaped lamellae, wherein the lamellae are formed on a radially outward-facing wall side and/or a radially inward-facing wall side of the anode head, wherein the radially outward-facing wall side and the radially inward-facing wall side also delimit the radially outer portion of the flow path.

12. The X-ray tube according to claim 7, wherein the rectification elements are formed at least in part by a plurality of parallel hollow structures arranged in the radially outer portion of the flow path.

13. The X-ray tube according to claim 6, wherein the distribution structures in a subportion of the radially outer portion of the flow path far from the target comprise one or more swirl elements, which are arranged between the at least one inlet connection and an outlet-side annular gap and with which a swirl with respect to the central axis can be introduced into the cooling fluid flow.

14. The X-ray tube according to claim 13, wherein the at least one swirl element runs helically around the central axis of the anode head, thereby establishing at least one helical channel for the cooling fluid flow.

15. The X-ray tube according to claim 13, wherein multiple swirl elements run helically around the central axis of the anode head, thereby establishing multiple, azimuthally and/or axially offset helical channels for partial flows of the cooling fluid.

16. The X-ray tube according to claim 6, wherein an equalization zone for the cooling fluid flow is established between distribution structures of a subportion of the radially outer portion far from the target and distribution structures of a subportion of the radially outer portion near the target, wherein the equalization zone is established as an annular gap.

17. The X-ray tube according to claim 1, wherein the anode head is formed with a first flow element and a second flow element, which are inserted into one another and form at least part of the flow path between them.

18. The X-ray tube according to claim 1, wherein at least the radially inner portion of the flow path, and also the cooling gap, are partially delimited by a pin, which projects from the end face of the anode head into the interior of the anode head.

19. The X-ray tube according to claim 7, wherein the distribution structures in a subportion of the radially outer portion of the flow path far from the target comprise one or more swirl elements, which are arranged between the at least one inlet connection and an outlet-side annular gap and with which a swirl with respect to the central axis can be introduced into the cooling fluid flow.

20. An X-ray tube arrangement, comprising the x-ray tube according to claim 1 and a supply device for a cooling fluid, wherein the supply device provides fresh cooling fluid at a discharge outlet and the discharge outlet is connected to the at least one inlet connection, wherein the supply device further receives heated cooling fluid at a return inlet and the outlet connection is connected to the return inlet.

21. Use of the x-ray tube according to claim 1, wherein, during operation of the x-ray tube electrons from the source for releasing electrons impinge on an annular, excited region of the target, thereby generating x-ray radiation, and cooling fluid flows from radially outside to radially inside in the cooling gap opposite the excited region.

22. The use according to claim 21, wherein a mean flow velocity of the cooling fluid in the cooling gap opposite the excited region remains the same or increases from radially outside to radially inside, the increases being at most 25%.

23. The X-ray tube according to claim 1, wherein a local cross-sectional area of the cooling gap in the region of the anode head opposite the excited region of the target decreases continuously from radially outside to radially inside by at most 20%.
